(19) United States
(12) Patent Application Publication
(10) Pub. No.: US 2012/0183793 A1
(43) Pub. Date: Jul. 19, 2012

(54) METHOD FOR SELECTIVELY METALLIZING A SUBSTRATE AND INTERCONNECT DEVICE PRODUCED BY THIS METHOD

(75) Inventors: Wolfgang John, Neustadt am Ruebenberge (DE); Bernd Roesener, Porta Westfalica (DE)

(73) Assignee: LPKF LASER & ELECTRONICS AG, Garbsen (DE)

(21) Appl. No.: 13/350,871

(22) Filed: Jan. 16, 2012

(30) Foreign Application Priority Data
Jan. 14, 2011 (DE) 10 2011 000 138.7

(51) Int. Cl. B05D 3/06; B32B 15/08; B05D 3/12

(52) U.S. Cl. 428/472.2; 427/554; 427/532; 427/553; 427/290

(57) ABSTRACT

A method for selectively metallizing a substrate having a significant content of a plastics material includes ablating a layer of the substrate close to a surface of the substrate in a region of the substrate to be metallized so as to provide access to an additive having at least one compound from a substance family of aluminosilicates that is incorporated in the plastics material and to open one of a pore or a pore structure of the aluminosilicates in the region of the substrate to be metallized. The substrate is metallized with no external current starting inside the pore or the pore structure so as to incorporate a precious metal in the substrate and then at an outer edge region of the pores so as to form a planar metallization layer on the surface of the substrate

CROSS REFERENCE TO PRIOR APPLICATIONS

Priority is claimed to German Patent Application No. DE 10 2011 000 138.7, filed on Jan. 14, 2011, the entire disclosure of which is hereby incorporated by reference herein.

### FIELD

The invention relates to a method for selectively metallizing a substrate having a significant material content of a plastics material.

### BACKGROUND

Since ABS (acrylonitrile butadiene styrene) injection-moulded plastics material parts were first metallized with strong bonding by wet-chemical methods, in the early 1960s, there have been a wide range of method developments for also metallizing commercial plastics materials such as polyamide (PA), polybutylene terephthalate (PBT) or polycarbonate (PC), having continued use temperatures of up to approximately 150° C., and even more strongly heat-resistant high-performance plastics materials, such as polyether imide (PI), polyphenylene sulphide (PPS), polyether ether ketone (PEEK) or liquid crystal polymer (LCP), with strong bonding for the purposes of functional and/or decorative surface finishing.

More generally, the pre-treatment of plastics material surfaces before they are metallized can be subdivided into the process steps of conditioning, crystallisation and activation.

Technical literature describes a wide range of different mechanical, chemical and physical methods for the surface pre-treatment of plastics material surfaces, and these methods, in particular the chemical methods, are often adapted to the nature of the plastics material surface. It is essential to all these methods that the plastics material substrate surface is solubilised so as to provide the required adhesion base for the metal which is to be deposited. In the chemical methods, roughening is achieved by corrosion or thickening and extracting components from the surface, and often simultaneously manifests as a surface enlargement, very often in connection with hydrophilisation.

Thus, patent application DE 100 54 544 A1 describes a method for chemical metallization of surfaces, in particular surfaces made of acrylonitrile butadiene styrene copolymerisates (ABS) and mixtures (blends) thereof with other polymers, in that the surfaces thereof are corroded in highly concentrated solutions of Cr(VI) ions in sulphuric acid.

The aggressive corrosion attack of these solutions breaks down the butadiene components of the ABS substrate matrix on the surface by oxidation, and selectively extracts the oxidation products from the surface, and thus provides a porous substrate surface having caverns, which provides a high bonding strength for the subsequent precious metal crystallisation and chemical metallization as a result of what is known as the “push-button effect”(see also the Galvanotechnik series from Eugen G. Leuze Verlag; Schuchentrunk, R. et al.; “Kunststoffmetallisierung”, Bad Saulgau 2007; ISBN 3-87480-225-6).

For the pre-treatment of the surface of polyamide shaped parts, prior to the currentless metallization, EP 0 146 724 B1 describes treatment in a mixture of halides of the elements in group IA or IIA of the periodic table with sulphates, nitrates or chlorides of groups IIIA, IIIB, IVA, IVB, VIA and VIIA or of non-precious metals of group VIIIA of the periodic table, in a non-corrosive organic thickener or solvent and an organometallic complex compound of elements of group IB or VIIIA of the periodic table.

DE 10 2005 051 632 B4 is also based on pre-treating plastics materials, and specifically polyamides, prior to chemical metallization, by a method in which the plastics material surfaces are treated with a corrosive solution comprising a halide and/or nitrate of the group consisting of Na, Mg, Al, Si, Sc, Ti, V, Cr, Mn, Fe, Co, Ni, Cu, Ca and Zn, said solution comprising a soluble fluoride in the form of a coordination compound of general formula M¹(HF₂).

In the past, use was often made of the two-component injection moulding method to produce selectively metallized plastics material components. Especially in the 1990s, two possible method types had emerged for the production of for example three-dimensional injection-moulded interconnect devices (3-D MIDs), namely the SKW method (Sankyo Kasei Wiring) and PCK method (Printed Circuit Board Kollmorgan); see also “Proceedings of 1^{st} International Congress Molded Interconnect Devices”, Sep. 28-29, 1994, Erlangen, Germany, published by Research Association Interconnect Devices 3-D MID e.V., ISBN 3-87525-062-1.

Both methods feature the use of a combination of a plastics material, which can be metallized or can be activated for metallization, with a material which cannot be metallized or cannot be pre-treated so as to be activated for metallization.

In the meantime, during the development of this technology, catalytic plastics materials, for example doped with palladium, have been used as materials for the metallizable components. After the two-component injection moulding from a palladium-doped and a non-palladium-doped plastics material, the surface regions of the injection-moulded part, in which the catalytic plastics material components are present, have to be pre-treated in such a way that it is possible for the currentless metallization bath to access the palladium crystals incorporated into the plastics material. If LCP is used as a high-performance material, as is frequently the case for MID components, this pre-treatment is carried out by corroding the surface in highly alkaline solutions.

It is described in DE 100 54 088 C1 that three-dimensional interconnect devices (3-D MIDs) can be produced from an advantageous combination of high-performance materials such as LCP and syndiotactic polystyrene in two-component injection-moulding methods, in such a way that the catalytic LCP component can be selectively metallized after corrosion in 10-15 of normal sodium hydroxide solution at temperatures of between 60° C. and 90° C. This corrosion step dissolves the injection-moulded skin of the LCP and the mineral filler particles embedded in the plastics material are extracted. This provides a porous surface again, which provides a good adhesion base for the subsequently deposited metallization.

After the plastics material surface is conditioned, crystallisation is carried out. During the crystallisation, palladium compounds are adsorbed onto the conditioned plastics material surface. This generally takes place in hydrochloric acid solutions, which comprise the palladium in either ionogenic or colloidal form. The ionogenic crystallisation is generally carried out using doubly-charged Pd²⁺, primarily in the form of the tetrachloropalladate(II) ion [PdCl₄]²⁻. By contrast, the colloidal crystallisation involves metal palladium, which is held in solution by a protective colloid. Tin(II) chloride SnCl₂ is generally used as the protective colloid, and forms a negatively charged protective shell around the palladium-tin cluster; this shell can interact with the dipoles of the water molecules, holding the metal cluster in solution. The cluster diameters vary within the range of 2 to 10 nm. The structure of the colloidally dissolved palladium-tin cluster has been described for example in R. L. Cohen; K. W. West, J. Electrochem Soc. 120, 502 (1973).

In the last step before the actual metallization of the plastics material surface, the crystallisation is followed by the activation, i.e. the formation of metal palladium crystals on the pre-treated surface.

If the crystallisation was ionogenic, the adsorbed palladium compounds are reduced to metal palladium by a reducing agent such as sodium hypophosphite NaH₂PO₂ or dimethyl aminoborane (CH₃)₂NH—BH₃.

After colloidal palladium crystallisation, where the metal palladium is already present but is bonded in the protective colloid, the protective colloid is destroyed on the substrate surface, with simultaneous adsorption of metal palladium on the plastics material surface. The person skilled in the art would refer to this as acceleration. Oxalic acid HOOC—COOH or tetrafluoroboric acid HBF₄ is used as an accelerant, and removes the SnCl₂ shell of the protective colloid, thus providing that the palladium clusters released from the protective shell are taken up directly onto the plastics material surface.

In the following metallization step, which in this case exclusively refers to a chemical metallization step with no external current, the palladium atoms which are produced following the ionogenic or colloidal crystallisation interfere with the metastable equilibrium of the electrolytes in that they catalyse the reduction reaction between the metal ions in the electrolyte and the reducing agent. Once the reaction has been initiated, the metal deposition continues by autocatalysis and subsequently the deposited metal itself catalyses the reduction reaction, similarly to the palladium clusters.

Selective metallization of plastics material components plays a particularly important role in the field of three-dimensional injection-moulded interconnect devices (3-D MIDs). This technology has continued to gain in importance in recent years, because when designing mechatronic systems, it can combine virtually complete design freedom of the plastics injection moulding method and the mechanical operation thereof with the possibilities of interconnect device production in an ideal manner.

An overview of the various production methods of MIDs can be found in the manual “Herstellungsverfahren, Gebrauchsanforderungen and Materialkennwerte Räumlicher Elektronischer Baugruppen 3-D MID”, published by Forschungsvereinigung Räumliche Elektronische Baugruppen 3-D MID e.V. D-Erlangen, Carl Hanser Verlag, Munich 2004 (ISBN 3-446-22720-2).

As well as the aforementioned two-component injection moulding methods, in which metallizable and non-metallizable plastics materials are combined in one component and the circuit regions formed on the surface, generally as strip conductors, consisting of the metallizable components are subsequently selectively metallized, what is known as laser direct structuring has gained a substantial market share of MID production in recent years.

The basic principles of manufacturing strip conductors and methods for the manufacture thereof are described in EP 1 274 288 B1. In this case, additives, very generally consisting of metal oxides from the d and f blocks of the periodic table, in a particular embodiment consisting of spinels and in the most specific variant consisting of spinels comprising copper, are compounded into the plastics materials used as interconnect devices, and the plastics material components obtained are subsequently machined with the electromagnetic radiation of a laser. This provides slight removal at the surface of the plastics material component, combined with fracturing of the polymer surface, accompanied by the simultaneous formation of catalytically active crystals which originate from the effect of the laser beam on the additive incorporated in the plastics material. The components activated in this manner can subsequently be selectively copper-plated in a currentless copper bath.

Despite the great market success thereof in MID manufacture, and in particular in the field of mobile communications antenna manufacture, the method has the drawback that the additives used have an inherent black colour, and thus, at the concentrations necessary to generate sufficient activation for the subsequent metallization, the added plastics materials or the injection-moulded parts produced therefrom also take on a black colour. This restricts the design freedom, for example in the field of mobile telephones, in that covers which can expediently be provided on the inside with metal antenna structures can only be manufactured so as to be black on the outside, and accordingly have to be coloured in accordance with the desired design in a separate step, for example by lacquering.

A further drawback of the method is that the materials which tend to form a melt particularly easily during laser structuring or activation, in such a way that the activated additives are presumably re-encapsulated in part, are very difficult to metallize, including in particular AMS and PC/AMS blends, which are used almost exclusively for manufacturing mobile telephone antennae. In practice, these laser-structured parts are often provided in a two-step copper metallization process, the first copper bath consisting of a highly active chemical copper electrolyte, in which the parts are coated with approximately 1-3 μm of copper, so as subsequently to be copper-plated further to the desired layer thickness in a normally activated copper electrolyte. The person skilled in the art is aware that the service life of a highly active copper bath is very short, and it subsequently has to be rejected and disposed of This two-step copper bath sequence is therefore expensive and requires additional copper tank capacities, which either necessitate a longer metallization line or reduce the capacities by comparison with one-step operation.

WO 2008/119359 and “Proceedings of 8^{th} International Congress Molded Interconnect Devices”, Sep. 24-25, 2008, Nuremberg-Fuerth, Germany, published by Research Association Interconnected Devices 3-D MID e.V., also describe a laser-assisted method for selective metallization of plastics material surfaces for manufacturing three-dimensional interconnect devices, in which the surface is only roughened once, without the plastics material comprising an additive which would act as a catalyst for chemical copper-plating after the laser structuring. In this case, the laser treatment takes place in liquids, in the simplest case in water. In this case, the subsequent palladium activation and metallization are again carried out in accordance with the known above-described prior art.

It is apparent that the often three-dimensional structuring of components with the laser within liquids represents a manner of proceeding which can only be carried out in some cases in practice, and does not allow the method to be carried out economically.

### SUMMARY OF THE INVENTION

In an embodiment, the invention provides a method for selectively metallizing a substrate having a significant content of a plastics material. A layer of the substrate close to a surface of the substrate in a region of the substrate to be metallized is ablated so as to provide access to an additive having at least one compound from a substance family of aluminosilicates that is incorporated in the plastics material and to open one of a pore or a pore structure of the aluminosilicates in the region of the substrate to be metallized. The substrate is metallized with no external current starting inside the pore or the pore structure so as to incorporate a precious metal in the substrate and then at an outer edge region of the pores so as to form a planar metallization layer on the surface of the substrate

### DETAILED DESCRIPTION

An embodiment of the present invention provides a substantially improved method.

In an embodiment, the plastics material comprises as an additive at least one compound from the substance family of the aluminosilicates, in particular the tectoaluminosilicates, and in that the ablation provides accessibility to the aluminosilicates incorporated in the plastics material and opening of the pores or pore structure of the aluminosilicates in the regions of the plastics material surface which are to be metallized, so as to achieve the incorporation of precious metals, in particular palladium, and in that finally metallization with no external current is carried out, in which metal is deposited, starting inside the pores or the pore structure but also in the outer edge region of the pores, in such a way that a planar metallization layer forms on the surface of the substrate. Thus, in particular, substances are incorporated into the polymer matrix which by their very nature have cavity structures, the cavity structures of these substances being opened after selective ablation of the surface skin of the plastics material bodies made from the polymer matrix, and precious metal crystallisation of the ablated regions subsequently taking place by the known methods which have proved themselves in plastics material metallization. For example, for this purpose one or more compounds from the group of natural or synthetic tectoaluminosilicates, generally known as zeolites, are incorporated in any desired thermoplastic or thermosetting polymer matrix. The primary structural units of zeolites are TO₄ tetrahedrons, the T position being taken up by silicon or aluminum. Bonding of the individual units results in a three-dimensional network, virtually all of the oxygen atoms being bonded to two tetrahedrons. However, by the empirical Loewenstein's rule, no two aluminum atoms can be bonded to the same oxygen atom. Since aluminum is only triply positively charged, but is quadruply coordinated, there is a negative charge for every AlO₄ tetrahedron. This is compensated by cations, which are not directly incorporated into the network. Examples of ions of this type are K, Na, Ca, Li, Mg, Sr, Ba etc., which can easily be exchanged.

In an embodiment, in the preparation of synthetic zeolites, Ga, Ge, Be and P inter alia are also used as tetrahedron cations, as well as alkali metals, alkaline earths, rare earths and organic complexes as “extraframework cations”.

In this regard, according to an embodiment of the invention, the term zeolite, which strictly speaking is reserved specifically for a structural framework of AlO₄ and SiO₄ tetrahedrons, also includes structural frameworks understood as modified zeolites, in which elements other than Al and Si are to be placed in the T position.

In practice, the structure and the formation of ducts and pores in zeolites play a particular role in applications as ion exchangers and during use as catalysts, and are also exploited in the present invention.

Surprisingly, it has now been found that incorporating dried natural zeolites or synthetic zeolites or appropriately modified zeolites, at concentrations of between 1 and 40% by weight, preferably between 2 and 30% by weight, into a plastics material matrix consisting of any desired thermoplastic or thermosetting polymer results in a material which is adapted for further processing to form a shaped plastics material body and which forms the basis for producing three-dimensional interconnect devices.

In an embodiment, the zeolites are expediently selected based on the pore openings thereof to the internal cavities thereof, preferably from the group of mesoporous or macroporous zeolites.

Adapted variants for shaping the polymer mixture are injection moulding methods, extrusion and compression methods.

In an embodiment, for modifying the mechanical or other properties of the resulting component, it can be expedient to incorporate other additives into the polymer mixture in parallel. Examples of further additives of this type are reinforcing substances, coloured fillers, or substances which improve the rheological or general processing properties etc.

In an embodiment, in a second step, a thin layer of material is subsequently removed (ablated) in the regions of the surface of the resulting interconnect device which are to be metallized in a subsequent metallization step. All material removal methods are inherently adapted for this purpose, including for example mechanical milling, some plasma methods and particularly preferably methods which operate based on the electromagnetic radiation of a laser.

In this context, the wavelength range of the electromagnetic radiation of a laser can be in the range between 193 nm and 10,600 nm, preferably in the range between 355 nm and 1,064 nm.

In a further embodiment of the invention, substances which improve the absorption of the laser light at the respective wavelength in the polymer material may also be mixed into the polymer matrix. In this context, concentrations of between 0.1 and 10% by weight based on the total weight of the polymer may be used.

In the subsequent steps of crystallising and activating the selectively ablated surface of the plastics material body, reference is made to the standard methods outlined in the description of the prior art.

Thus, in an embodiment, the plastics material body is initially either immersed in a solution containing palladium, and thus ionogenically crystallised, or colloidally crystallised by immersion in a Pd/SnCl₂ solution.

According to an embodiment of the invention, it is to be assumed that in the case of ionogenic crystallisation the Pd² ions diffuse into the cavities of the now exposed zeolite, where they are exchanged for cations of the zeolite framework.

It is also to be assumed according to an embodiment of the invention that in the case of colloidal crystallisation, presuming an adapted pore width based on selection of the appropriate zeolite, the palladium tin clusters diffuse into the cell structures of the zeolite.

After thorough rinsing of the parts pre-treated in this manner, according to an embodiment of the invention the reduction to metal palladium takes place and the protective colloid is split, specifically directly into the cavities of the zeolite, by immersion in the corresponding reaction solution.

Finally, according to an embodiment of the invention the surfaces pre-treated in this manner are treated in a conventional commercial chemical copper bath, and it is assumed that the copper-plating starts inside the cavities of the zeolite and subsequently continues on the surface of the ablated regions, and thus high bonding strength of the finished metallized layer is provided.

In the following, the invention is described in greater detail by way of embodiments.

### Variant 1

After previously drying for 4 hours at a temperature of 110° C., a natural colour granulate of a Bayblend T45 polycarbonate/acrylonitrile butadiene styrene blend from Bayer AG was milled in a 100 UPZ-II impact mill from Alpine.

In an asymmetric moved mixer, 540 g of the polymer powder obtained in this manner was mixed for 15 minutes with 60 g of a modified 13X zeolite from Süd-Chemie, which had previously been dewatered in a vacuum for 5 hours at 250° C.

This mixture was homogenised in a compounder from Dr. Collin, and subsequently the plastics material granulate obtained after comminution was injection-moulded to form plate-shaped test pieces of dimensions 60 mm×60 mm×2 mm in an injection moulding machine from Dr. Boy.

### Variant 2

After previously drying for a period of 3 hours at 120° C., an Ultradur B4520 naturally coloured polybutylene terephthalate (PBT) from BASF was milled, analogously to the first process step in variant 1.

In an asymmetric moved mixer, 480 g of the polymer powder obtained in this manner was mixed for 15 minutes with 60 g of a modified Pentasil zeolite from Zeochem, which had previously been dewatered in a vacuum for 5 hours at 250° C., along with 60 g talc having the trade name Finntalk M03-SQ, which had previously been dried for 2 hours at 200° C.

Analogously to variant 1, this mixture was compounded and injection-moulded to form plate-shaped test pieces.

### Variant 3

After previously drying for a period of 10 hours at 80° C., an HT2V-3X V0 partially aromatic copolyamide from EMS, previously coloured with 1% “Red X2GP” dye from Albion-Colours and filled with 30% glass fibre, was milled, analogously to the first process step in variant 1.

In an asymmetric moved mixer, 516 g of the polymer powder obtained in this manner was mixed for 15 minutes with 33 g of a modified 13X zeolite from Süd-Chemie, which had previously been dewatered in a vacuum for 5 hours at 250° C., along with 18 g of a Polestar 200R calcinated IR absorber from Imerys Performance & Filtration Materials.

Analogously to variant 1, this mixture was compounded and injection-moulded to form red-coloured plate-shaped test pieces.

### Variant 4

Rectangular test structures were inscribed in a plastics material plate obtained from variant 1 or 2, using a UV laser of wavelength 355 nm at a pulse energy of 35 μJ and a speed of 500 mm/s in one pass.

### Variant 5

Rectangular test structures were inscribed in a plastics material plate obtained from variant 3, using an Nd-YAG laser of wavelength 1054 nm at a pulse energy of 120 μJ and a speed of 4000 mm/s in two passes.

### Variant 6

A plurality of rectangular depressions having a depth of 0.15 mm, measured from the plate surface, were milled into the planar surface of a plastics material plate obtained from variant 1, with the aid of a CNC milling machine and using a double-cut miller having a diameter of 1.5 mm and a rotational speed of 18000 rpm.

### Variant 7

A plate treated using variants 4 to 6 was immersed in an aqueous solution comprising Pd² and having the example composition of 200 ml/l MID activator Ni from Atotech and 5 ml/l concentrated H₂SO₄, for 15 minutes at 50° C. with bath movement. Subsequently, the plate was rinsed in a counterflow cascade rinser and subsequently in deionised water.

Subsequently, the plate was treated in a reduction solution comprising dimethyl aminoborane and having the example composition of 25 ml/l Ultraplast BL 2220 Conditioner and 2.5 ml/l Ultraplast BL 2230 Additive from Enthone, for 5 minutes at 40° C. with bath movement, and subsequently rinsed again.

Immediately afterwards, the plate pre-treated in this manner was suspended in an activated Circuposit 4500 currentless copper bath from Dow Chemical at a working temperature of 54° C., and removed from the bath after approximately 45 minutes.

After thorough rinsing, the plate was dried. In the places on the plate which had previously been treated with the laser or into which depressed structures had been milled, uniform copper layers approximately 4 μm thick had been deposited selectively with sharp contours and with strong bonding.

### Variant 8

A further plate treated using variants 4 to 6 was immersed in a colloidal palladium catalyst solution having the example composition of 250 ml/l 37% HCl, 170 ml/l PdCl₂ and 15 g/l SnCl₂, for 5 minutes at 30° C. with bath movement. Subsequently, the plate was rinsed in a counterflow cascade rinser and subsequently in deionised water.

Subsequently, the plate was treated in an Enplate Accelerator 860 accelerant solution comprising HBF₄ from Enthone, for 3 minutes at room temperature with bath movement, and subsequently rinsed thoroughly again.

Immediately afterwards, the plate pre-treated in this manner was suspended in an activated M-Copper 85 currentless copper bath from MacDermid at a working temperature of 48° C., and removed from the bath after approximately 30 minutes.

After thorough rinsing, the plate was dried. In the places on the plate which had previously been treated with the laser or into which depressed structures had been milled, a uniform copper layer approximately 2 μm thick had been deposited selectively with sharp contours and with strong bonding.

### Variant 9

Immediately after the copper-plating, a sample plate obtained from variants 3 to 5 and selectively copper-plated using variant 7 was subjected to Pd activation in a conventional commercial Ronamerse SMT Catalyst CF bath from Dow Chemical, nickel-plated in a Niposit LT chemical nickel bath from Dow Chemical with approximately 4 μm NiP (4-6% phosphorus content) and subsequently provided with a flash gold layer approximately 0.1 μm thick from an Aurolectroless SMT-G currentless gold bath from Dow Chemical.

On the fields of the plates which are now copper-plated, nickel-plated and gold-plated, dots of a lead-free soldering paste were dispensed and previously tin-plated copper wires were laid in these dots. The soldering paste was melted on in a vapour phase soldering system, which had been loaded with the perfluorinated polyether “Galden HS/240” (trade name of Solvay Solexis S.p.A.) having a boiling point of 240° C. After the soldering, a non-porous soldering path could be recognised, and the removal test on the wires which had been soldered on revealed very high bonding strength of the metallization even after the soldering process.

While the invention has been described with reference to particular embodiments thereof, it will be understood by those having ordinary skill the art that various changes may be made therein without departing from the scope and spirit of the invention. Further, the present invention is not limited to the embodiments described herein; reference should be had to the appended claims.

What is claimed is:

1. A method for selectively metallizing a substrate having a significant content of a plastics material, the method comprising:
ablating a layer of the substrate close to a surface of the substrate in a region of the substrate to be metallized so as to provide access to an additive having at least one compound from a substance family of aluminosilicates that is incorporated in the plastics material and to open one of a pore or a pore structure of the aluminosilicates in the region of the substrate to be metallized; and
metallizing the substrate with no external current starting inside the pore or the pore structure so as to incorporate a precious metal in the substrate and then at an outer edge region of the pores so as to form a planar metallization layer on the surface of the substrate.

2. The method as recited in claim 1, wherein the substance family of the aluminosilicates includes tectoaluminosilicates.

3. The method as recited in claim 1, wherein the ablating is performed using electromagnetic radiation.

4. The method as recited in claim 3, wherein the electromagnetic radiation includes laser radiation.

5. The method as recited in claim 1, wherein the precious metal include palladium.

6. The method as recited in claim 3, wherein a wavelength of the electromagnetic radiation is in a range of between 193 nm and 10,600 nm.

7. The method as recited in claim 3, wherein a wavelength of the electromagnetic radiation is in a range of between 350 nm and 1,100 nm.

8. The method as recited in claim 1, wherein an open pore diameter of the aluminosilicates is at least greater than a kinetic diameter of a reactant involved in the incorporation of the precious metal.

9. The method as recited in claim 1, wherein a content of the additive is between 1 and 40 percent by weight of the overall mixture of the plastics material.

10. The method as recited in claim 1, wherein a content of the additive is between 2 and 30 percent by weight of the overall mixture of the plastics material.

11. The method as recited in claim 1, wherein the plastics material includes one of a thermoplastic and a thermosetting plastics material.

12. The method as recited in claim 11, wherein the thermoplastics material is one of injection-molded, extruded and film-formed.

13. The method as recited in claim 11, wherein the thermosetting plastics material is in a form of one of a compression-moulded plastics material and a liquid form.

14. The method as recited in claim 1, wherein the metallization is performed chemically in a chemically reductive metal bath.

15. The method as recited in claim 1, wherein the plastics material includes at least one inorganic or organic additive as an addition additive.

16. The method as recited in claim 15, wherein the additional additive includes an absorption maximum in one of the infrared, green and ultraviolet wavelength range and increases an absorptivity of the plastics material.

17. The method as recited in claim 1, wherein the metallizing includes substance transporting of one of ionogenic and colloidal precious metal into the pore or the pore structure and starting a chemical copper deposition based on predetermined secondary reactions.

18. The method as recited in claim 1, wherein the precious metal includes a palladium compound.

19. A three-dimensional interconnect device, produced according to the method as recited in claim 1.

20. An interconnect device comprising metallization on a substrate, produced according to the method as recited in claim 1.
